(19) United States
(12) Patent Application Publication
(10) Pub. No.: US 2020/0143160 A1
(43) Pub. Date: May 7, 2020

(54) DEVICE AND METHOD FOR PROCESSING IMAGE

(71) Applicant: FUJITSU LIMITED, Kawasaki-shi (JP)

(72) Inventors: Wei LIU, Beijing (CN); Jun SUN, Beijing (CN)

(73) Assignee: FUJITSU LIMITED, Kawasaki-shi (JP)

(21) Appl. No.: 16/669,543

(22) Filed: Oct. 31, 2019

(30) Foreign Application Priority Data
Nov. 6, 2018 (CN) 201811312165.7

(51) Int. Cl. G06K 9/00; G06K 9/62; G06K 9/20

(52) U.S. Cl. CPC G06K 9/00463; G06K 9/628; G06K 2209/011; G06K 9/00456; G06K 9/2072

(57) ABSTRACT

The disclosure relates to a method and a device for processing an image. The device includes a selecting unit configured to, by recognizing character blocks in the image using a convolutional network classifier or a fully convolutional network classifier, select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and a determining unit configured to determine an area of a middle address of a Japanese recipient address in the image, starting from the seed character block. At least one of the following effects can be achieved by the device and the method: improving efficiency and accuracy of recognizing the middle address of the Japanese recipient address.

### CROSS-REFERENCE TO RELATED APPLICATION

The present application claims priority to CN 201811312165.7, filed Nov. 6, 2018, the entire contents of which are incorporated herein by reference.

### FIELD

The present disclosure generally relates to the technical field of image processing, and in particular to a device and a method for processing an image containing a Japanese recipient address.

### BACKGROUND

Due to development of computer performance, OCR (Optical Character Recognition) techniques have been widely used in various fields of daily life. For example, OCR techniques are used to recognize text in a document image for further processing.

Recipient addresses often appear on postal matters such as parcels and letters. A Japanese recipient address generally includes three rows, including an upper row, a middle row and a lower row. An address segment in the upper row is referred to as an upper address and includes the address information of, for example, provinces, cities, and administrative districts. An address segment in the middle row is referred to as a middle address and includes a character selected from a character set S composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”. An address segment in the lower row is referred to as a lower address and includes detailed local address information.

It is desired to automatically classify objects according to the recipient addresses labeled on the objects. Further, it is desired to improve efficiency and accuracy of classification (that is, recognition).

### SUMMARY

In the following, an overview of the embodiments is given simply to provide basic understanding to some aspects of the present embodiments. It should be understood that this overview is not an exhaustive overview of the present embodiments. It is not intended to determine a critical part or an important part of the present embodiments, nor to limit the scope of the present embodiments. An object of the overview is only to give some concepts in a simplified manner, which serves as a preface of a more detailed description described later.

According to an aspect of the present disclosure, a device for processing an image is provided. The device includes: a selecting unit configured to, by recognizing character blocks in the image using a convolutional network (CNN) classifier or a fully convolutional network (FCN) classifier, select in the image a seed character block satisfying a condition that a result of recognizing the seed character block is one of elements of a character set S composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and a determining unit configured to determine an area of a middle address of a Japanese recipient address in the image, starting from the seed character block.

According to an aspect of the present disclosure, it is provided a method of processing an image. The method includes the steps of recognizing character blocks in the image by using a convolutional network classifier or a fully convolutional network classifier, to select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and determining, an area of a middle address of a Japanese recipient address in the image, starting from the seed character block.

According to an aspect of the present disclosure, it is provided a method of recognizing a Japanese recipient address in an image. The method includes determining, by using a recognition result of an FCN classifier, characters in a middle address in the image, determining, by using a recognition result of a CNN classifier, characters in an upper address in the image, and determining, by using the recognition result of the CNN classifier, characters in a lower address in the image.

According to an aspect of the present disclosure, it is provided a method of classifying a postal matter having a Japanese recipient address. The method includes classifying the postal matter based on the Japanese recipient address that is recognized according to the present disclosure.

According to an aspect of the present disclosure, it is provided a device for classifying a postal matter having a Japanese recipient address. The device is configured to classify the postal matter based on the Japanese recipient address that is recognized according to the present disclosure.

According to an aspect of the present disclosure, it is provided a storage medium on which program codes that are readable by an information processing device are stored. When being executed on the information processing device, the program codes cause the information processing device to perform the above methods according to the present disclosure.

According to an aspect of the present disclosure, it is provided an information processing device including a central processing unit. The central processing unit is configured to perform the above method according to the present disclosure.

One of the following effects can be achieved by the device and the method: improving degree of accuracy and recognition efficiency of recognizing an address in a Japanese recipient address.

### BRIEF DESCRIPTION OF THE DRAWINGS

The present disclosure may be better understood by referring to the following description given in conjunction with the accompanying drawings. The accompanying drawings, together with the following detailed description, are included in this specification and form a part of this specification. In the drawings:

FIG. 1 is an exemplary block diagram of a device for processing an image according to an embodiment of the present disclosure;

FIG. 2 shows an exemplary image of an image to be processed according to the present disclosure;

FIG. 3 shows character blocks obtained by performing over-segmentation on the image; digit

FIG. 4 is an exemplary flow chart of a method for selecting a seed character block according to an embodiment of the present disclosure;

FIG. 5 is an exemplary flow chart of a method for selecting a seed character block according to an embodiment of the present disclosure;

FIG. 6 is an exemplary flow chart of a method for selecting a seed character block according to another embodiment of the present disclosure;

FIG. 7 is an exemplary flow chart of a method for determining a left boundary of an area of a middle address of a Japanese recipient address according to an embodiment of the present disclosure;

FIG. 8 is an exemplary flow chart of a method for determining a right boundary of an area of a middle address of a Japanese recipient address according to an embodiment of the present disclosure;

FIG. 9 is an exemplary flow chart of a method for processing an image according to an embodiment of the present disclosure;

FIG. 10 is an exemplary flow chart of a method for recognizing a Japanese recipient address in an image according to an embodiment of the present disclosure; and

FIG. 11 is an exemplary block diagram of an information processing device according to an embodiment of the present disclosure.

### DETAILED DESCRIPTION

An exemplary embodiment will be described hereinafter in conjunction with the accompanying drawings. For the purpose of conciseness and clarity, not all features of an embodiment are described in this specification. However, it should be understood that multiple decisions specific to the embodiment may be made in a process of developing any such embodiment to realize a particular object of a developer, and these decisions may change as the embodiments differs.

Here, it should also be noted that in order to avoid obscuring the embodiments due to unnecessary details, only an apparatus structure closely related to the solution according to the embodiments are illustrated in the accompanying drawing, and other details having little relationship to the embodiments are omitted.

It should be understood that, the present disclosure is not limited to the described implementations due to the following description with reference to the accompanying drawings. In the specification, in feasible cases, the embodiments can be combined mutually, features can be replaced or borrowed among different embodiments, or one or more features can be omitted in one of the embodiments.

An aspect of the present disclosure relates to a device for processing an image of a Japanese recipient address labeled on a postal matter.

Hereinafter, a device for processing an image according to the present disclosure is described with reference to FIG. 1.

FIG. 1 is an exemplary block diagram of a device 10 for processing an image according to an embodiment of the present disclosure.

The device 10 includes a selecting unit 11 and a determining unit 13. The selecting unit 11 is configured to, by recognizing character blocks in the image using a convolutional network (CNN) classifier or a fully convolutional network (FCN) classifier, select in the image a seed character block satisfying a condition that a result of recognizing the seed character block is one of elements of a character set S composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”.

The determining unit 13 is configured to determine an area of a middle address of a Japanese recipient address in the image, starting from the seed character block.

In the present disclosure, the Japanese recipient address labeled on the postal matter may be a character string having a standard format (such as various Japanese font formats used by a computer), a character string having a handwritten format, or a character string having a combined format, that is, including at least one character having a standard format and at least one character having a handwritten format. The solution of the present disclosure is applicable to process an image in which at least some characters in a Japanese recipient address have a handwritten format.

The image in the device 10 corresponds to the image of the Japanese recipient address labeled on a postal matter. The image (which is also referred to as a single-line Japanese recipient address image) includes an upper address, a middle address and a lower address successively arranged from left to right in a single line. The image may be acquired, for example, by acquiring an image of a Japanese recipient address labeled on a postal matter, and arranging, by using an information processing device, a middle address block corresponding to the middle address and a lower address block corresponding to the lower address in sequence following an upper address block corresponding to the upper address. Of course, if the Japanese recipient address labeled on the postal matter is in the form that the upper address, the middle address and the lower address are successively arranged in a single line, the image of the Japanese recipient address may be directly used.

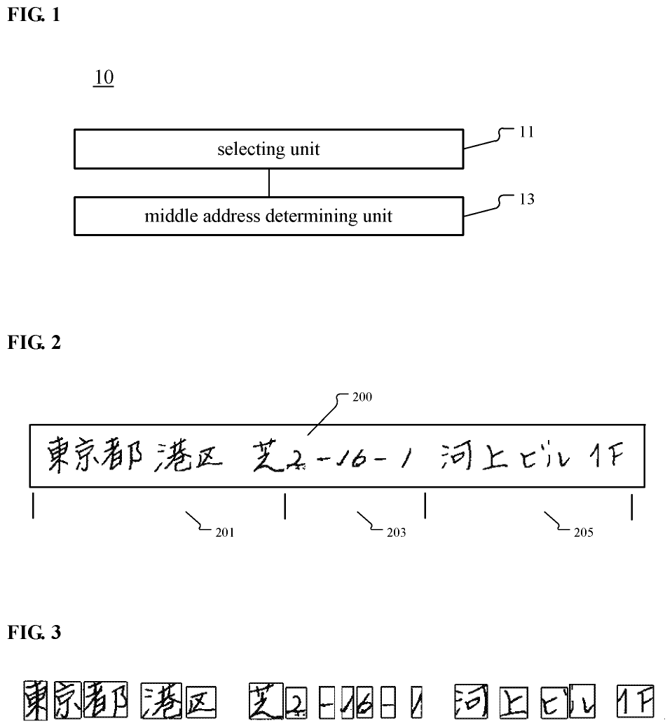

FIG. 2 shows an exemplary image 200 of an image to be processed according to the present disclosure, which includes an upper address block 201, a middle address block 203 and a lower address block 205. It is to be noted that the image 200 does not include the rectangular block and the four vertical lines under the rectangular block shown in FIG. 2. The four vertical lines are shown in FIG. 2 only for illustrating areas occupied by the respective address blocks.

The CNN classifier in the device 10 is a neural network based classifier. The CNN classifier is trained by using samples. For a character block to be classified, at least one candidate character and a CNN classification confidence of each candidate character can be obtained by using the CNN classifier as a recognition result. The confidence is used to indicate a degree of trust that the character block is classified as the corresponding candidate character, that is, each candidate character of each character block has a corresponding CNN classification confidence. The number of obtained candidate characters is related to the configuration of the CNN classifier. The CNN classifier may be configured such that when a target character block is classified by using the CNN classifier, only a CNN classification result regarding a specific character set of the target character block is obtained (ie, one or more characters in the specific character set that are similar to a character in the target character block and the CNN classification confidence are obtained), regardless of whether the character corresponding to the target character block is outside the specific character set. The specific character set may be, for example, a set S of characters, a set of numbers which is composed of characters “0”, “1”, “2”, “3”, “4”, “5”, “6”, “7” “,” “8” and “9”. When characters in a Japanese address in an image are classified by using the CNN classifier, it is preferable to set the CNN classifier to output only the classification with the largest confidence for each character block. After multiple characters in the Japanese address in the image is classified by using the CNN classifier, a set of classifications of the characters may include the same classification. However, the positions of the character blocks corresponding to the same classification are obviously different, and corresponding confidences may be different.

A single-line Japanese recipient address image may be segmented to determine an area or a location of each character block, thereby facilitating targeted recognition. The segmentation method may be an over-segmentation method.

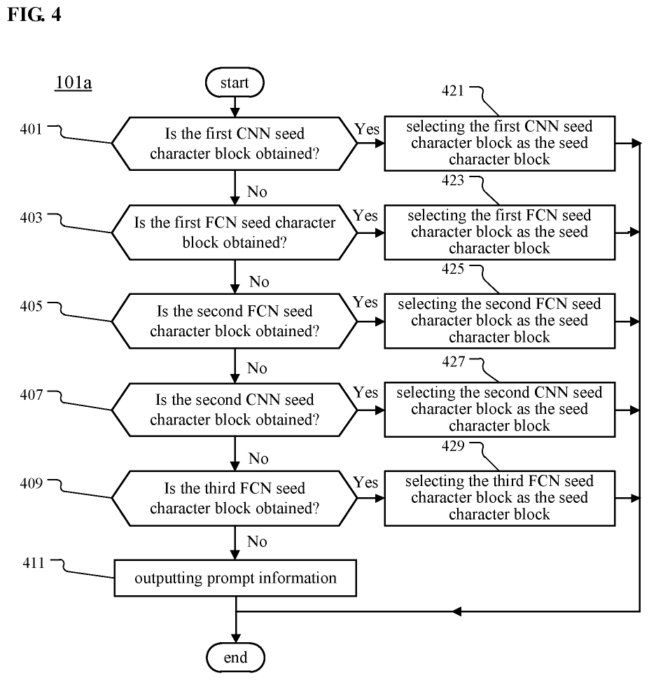

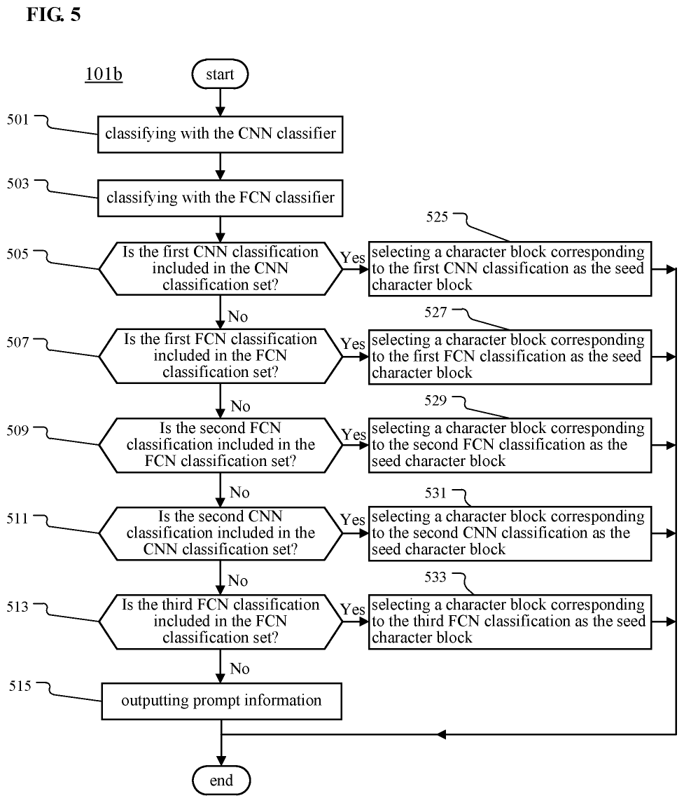

FIG. 3 shows character blocks obtained by performing over-segmentation on the image 200. Areas in which the character blocks are located are shown by rectangular boxes in Figure. In one embodiment, a gap between adjacent character blocks (i.e., a width of the gap) is calculated based on the character blocks, and a median value of multiple gaps is determined. The median value is used for determining an area of a middle address in the Japanese recipient address, which is described later.

The FCN classifier in the device 10 is also a neural network based classifier. The FCN classifier is trained by using samples. For a character block to be classified, at least one candidate character and an FCN classification confidence of each candidate character can be obtained by using the FCN classifier as a recognition result. The confidence is used to indicate a degree of trust that the character block is classified as the corresponding candidate character, that is, each candidate character of each character block has a corresponding FCN classification confidence. The number of obtained candidate characters is related to the configuration of the FCN classifier. The FCN classifier may be configured to determine a degree of trust that a character block to be classified in the image corresponds to a character in a character set S, regardless of whether the Japanese block to be classified is a character other than characters in the character set S. For example, the FCN classifier is configured to provide an FCN classification result regarding the character set S for a character block of which a center point is located at Pk (the FCN classification result includes at least one candidate character, and an FCN classification confidence of each candidate character, the candidate character belongs to the character set S). The FCN classifier does not determine whether the classification of the character block of which the center point is located at Pk is an element (ie, a character) other than the elements in the character set S. When characters in a Japanese address in an image are classified by using the FCN classifier, it is preferable to set the FCN classifier to output only the classification with the largest confidence for each character block. After multiple characters in the Japanese address in the image is classified by using the FCN classifier, a set of classifications of the characters may include the same classification. However, the positions of the character blocks corresponding to the same classification are obviously different, and corresponding confidences may be different.

In one embodiment, for a single-line Japanese recipient address image, with the FCN classifier, character blocks belonging to the character set S can be found, and positions (for example, coordinates), confidences, and categories (that is, which character in the character set S) of the character blocks can be obtained. For example, for a character X in the single-line Japanese recipient address image that is not in the character set S, the category is selected as a character category in the character set S that is close to the character X, and the confidence has a small value, such as 0 or a value close to 0; for a character Y in the single-line Japanese recipient address image that belongs to the character set S, the category is selected as a character category Y in the character set S and/or a character category similar to the character Y, and the confidence has a larger value, such as a value of 255 or close to 255 (where the degree of trust is represented by a value between 0 and 255, and a larger value indicates a higher degree of trust).

FIG. 4 is an exemplary flow chart of a method 101a for selecting a seed character block according to an embodiment of the present disclosure. The selecting unit 11 in the device 10 may be configured to implement the method 101a.

In step 401, whether a first CNN seed character block is obtained or not is determined by using a CNN classifier. If the first CNN seed character block is obtained when classifying the character blocks in the image by using the CNN classifier, step 421 is performed to select the first CNN seed character block as the seed character block. The first CNN seed character block satisfies the following condition: a largest CNN classification confidence of a CNN classification of the first CNN seed character block with respect to a first character subset is larger than a first CNN threshold, and the first CNN seed character block has a digit character block directly adjacent to the first CNN seed character block. The first character subset is composed of characters “ [symbol] ”, “ [symbol] ”, “ [symbol] ”, “ [symbol] ” and “ [symbol] ”. The digit character block satisfies the following condition: a confidence that the character block is recognized as one of characters “0”, “1”, “2”, “3”, “4”, “5”, “6”, “7”, “8” and “9” is larger than a predetermined threshold. The digit character block being directly adjacent includes: the digit character block being directly adjacent to the character block of interest on the left side of the character block of interest, and the digit character block is directly adjacent to the character block of interest on the right side of the character block of interest. In the present disclosure, a character block of interest and a digit character block are considered to be adjacent as long as one of two cases of being directly adjacent is satisfied.

When the classification of character blocks in the image is determined by using the CNN classifier, recognition may be performed block by block from left to right, from right to left, or in other predetermined orders.

In step 401, when determining a digit character block, the CNN classifier can still be used. In an alternative embodiment, other classifiers capable of recognizing digit character blocks may also be used to determine whether the character block is a digit character block, such as an FCN classifier or a classifier dedicated to recognizing digit character blocks. The position of the character block may be represented by a serial number (index) of the character block, or by the coordinates of the center position of the character block. The two representation methods have correspondence and can be switched to one another.

If the first CNN seed character block is not obtained when classifying the character blocks in the image by using the CNN classifier in step 401 (that is, the first CNN seed character block meeting the condition is not obtained after CNN classification is performed on the last character block in the image), step 403 is performed to determine whether a first FCN seed character block is obtained by using the FCN classifier. If the first FCN seed character block is obtained when classifying the character blocks in the image by using the FCN classifier, step 423 is performed to select the first FCN seed character block as the seed character block. The first FCN seed character block satisfies the following condition: a largest FCN classification confidence of an FCN classification of the first FCN seed character block with respect to the first character subset is larger than a first FCN threshold, and the first FCN seed character block has a digit character block directly adjacent to the first FCN seed character block.

In step 403, when determining a digit character block, the FCN classifier can still be used. In an alternative embodiment, other classifiers capable of recognizing digit character blocks may also be used to determine whether the character block is a digit character block, such as a CNN classifier or a classifier dedicated to recognizing digit character blocks.

If the first FCN seed character block is not obtained when classifying the character blocks in the image by using the FCN classifier in step 403 (that is, the first FCN seed character block meeting the condition is not obtained after FCN classification is performed on the last character block in the image), step 405 is performed to determine whether a second FCN seed character block is obtained by using the FCN classifier. If the second FCN seed character block is obtained when classifying the character blocks in the image by using the FCN classifier, step 425 is performed to select the second FCN seed character block as the seed character block. The second FCN seed character block satisfies the following condition: an FCN classification confidence of an FCN classification of the second FCN seed character block with respect to the character “−” is larger than a second FCN threshold, and the second FCN seed character block has the digit character block directly adjacent to the second FCN seed character block. For the method for determining the digit character block, one can refer to the method adopted in step 403. For example, the digit character block may be determined by using the FCN classifier.

If the second FCN seed character block is not obtained when classifying the character blocks in the image by using the FCN classifier in step 405 (that is, the second FCN seed character block meeting the condition is not obtained after FCN classification is performed on the last character block in the image), step 407 is performed to determine whether a second CNN seed character block is obtained by using the CNN classifier. If the second CNN seed character block is obtained when classifying the character blocks in the image by using the CNN classifier, step 427 is performed to select the second CNN seed character block as the seed character block. The second CNN seed character block satisfies the following condition: a largest CNN classification confidence of a CNN classification of the second CNN seed character block with respect to a digit set is larger than a second CNN threshold, and the second CNN seed character block has the digit character block directly adjacent to the second CNN seed character block. The digit set is composed of characters “0”, “1”, “2”, “3”, “4”, “5”, “6”, “7”, “8” and “9”.

If the second CNN seed character block is not obtained when classifying the character blocks in the image by using the CNN classifier in step 407 (that is, the second CNN seed character block meeting the condition is not obtained after CNN classification is performed on the last character block in the image), step 409 is performed to determine whether a third FCN seed character block is obtained by using the FCN classifier. If the third FCN seed character block is obtained when classifying the character blocks in the image by using the FCN classifier, step 429 is performed to select the third FCN seed character block as the seed character block. The third FCN seed character block satisfies the following condition: a largest FCN classification confidence of an FCN classification of the third FCN seed character block with respect to the digit set is larger than a third FCN threshold, and the third FCN seed character block has the digit character block directly adjacent to the third FCN seed character block. For the method for determining the digit character block, one can refer to the method adopted in step 403. For example, the digit character block may be determined by using the FCN classifier.

If the third FCN seed character block is not obtained when classifying the character blocks in the image by using the FCN classifier in step 409 (that is, the third FCN seed character block meeting the condition is not obtained after FCN classification is performed on the last character block in the image), step 411 is performed to output prompt information, in order that a user performs a corresponding operation on the image in such condition. The prompt information may be information indicating that the seed character block is not found, such as “seed character block not found” or “seed character block not discovered”.

It is to be noted that, the last character block mentioned above does not refer to the last character block of the string in the image, but refers to the last character block to be classified in an entire character string in the image when classifying the character blocks in the character string.

In the method 101a of selecting the seed character block, the seed character block is selected by using the CNN classifier and the FCN classifier, to accurately and rapidly determine the seed character block. Moreover, the characters in the middle address are classified into three categories (the first character subset, the character “−”, and the digit set). Recognition is performed according to the categories and priorities, which is advantageous for further improving the accuracy of the recognition. In the method 101a, after a character block is recognized, it is determined whether it is a seed character block. If the character block is a seed character block, a selection step is performed, and the method 101a ends, which is advantageous for saving processing time.

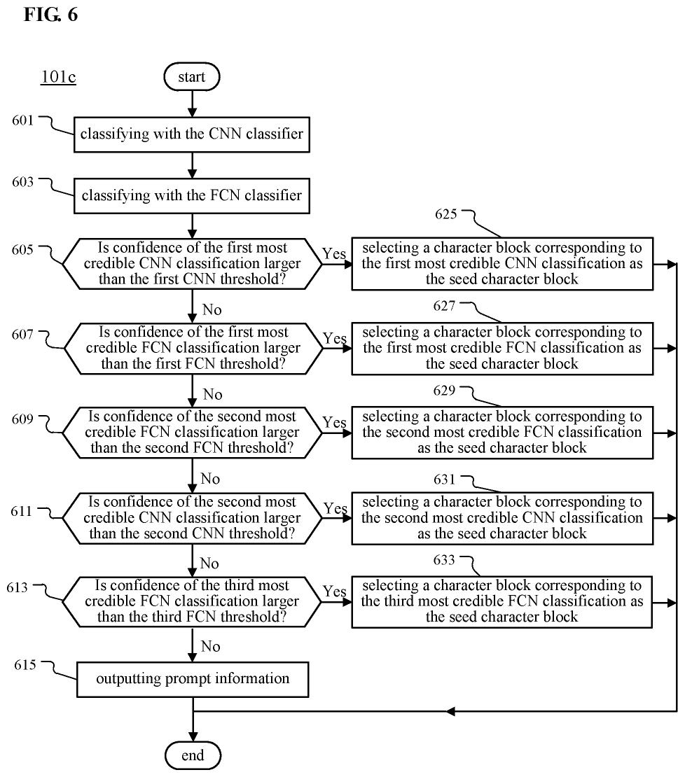

FIG. 5 is an exemplary flow chart of a method 101b for selecting a seed character block according to an embodiment of the present disclosure. The selecting unit 11 in the device 10 may be configured to implement the method 101b.

In step 501, the CNN classification of each character block and the CNN classification confidence of the CNN classification are determined by classifying character blocks with respect to the character set S by using the CNN classifier. The CNN classification of each character block may be the classification with the largest confidence among the CNN candidate classifications of the character block with respect to the character set S. In an embodiment of the present disclosure, the recognition result of each character block by the CNN classifier may be stored (for example, for each character block, the first five recognition results with the confidences being sorted from high to low are stored, and each recognition result includes a classification and a confidence) for subsequent use such that character blocks do not need to be repeatedly recognized.

In step 503, the FCN classification of each character block and the FCN classification confidence of the FCN classification are determined by classifying character blocks in the image with respect to the character set S by using the FCN classifier. The FCN classification of each character block may be the classification with the largest confidence among the FCN candidate classifications of the character block with respect to the character set S. In an embodiment of the present disclosure, the recognition result of each character block by the FCN classifier may be stored (for example, for each character block, the first five recognition results with the confidences being sorted from high to low are stored, and each recognition result includes a classification and a confidence) for subsequent use such that character blocks do not need to be repeatedly recognized.

In step 505, it is determined whether a CNN classification set composed of CNN classifications includes a first CNN classification that satisfies the following condition: the first CNN classification belongs to the first character subset, the first CNN classification confidence corresponding to the first CNN classification is larger than the first CNN threshold, and the character block corresponding to the first CNN classification has a digit character block directly adjacent to the character block. The first character subset is composed of characters “ [symbol] ”, “ [symbol] ”, “ [symbol] ”, “ [symbol] ” and “ [symbol] ”. The digit character block satisfies the following condition: a confidence that the character block is recognized as one of characters “0”, “1”, “2”, “3”, “4”, “5”, “6”, “7”, “8” and “9” is larger than a predetermined threshold.

If it is determined in step 505 that the CNN classification set includes the first CNN classification, step 525 is performed to select the character block corresponding to the first CNN classification as a seed character block.

If it is determined in step 505 that the CNN classification set does not include the first CNN classification, step 507 is performed to determine whether an FCN classification set composed of FCN classifications includes a first FCN classification that satisfies the following condition: the first FCN classification belongs to the first character subset, a first FCN classification confidence corresponding to the first FCN classification is larger than a first FCN threshold, and the character block corresponding to the first FCN classification has a digit character block directly adjacent to the character block. The digit character block may be determined by directly using the generated FCN classification result, or by using other classifiers.

If it is determined in step 507 that the FCN classification set includes the first FCN classification, step 527 is performed to determine the character block corresponding to the first FCN classification as the seed character block.

If it is determined in step 507 that the FCN classification set does not include the first FCN classification, step 509 is performed to determine whether the FCN classification set includes a second FCN classification that satisfies the following condition: the second FCN classification is the character “−”, a second FCN classification confidence corresponding to the second FCN classification is larger than a second FCN threshold, and a character block corresponding to the second FCN classification has a digit character block directly adjacent to the character block.

If it is determined in step 509 that the FCN classification set includes the second FCN classification, step 529 is performed to select the character block corresponding to the second FCN classification as the seed character block.

If it is determined in step 509 that the FCN classification set does not include the second FCN classification, step 511 is performed to determine whether the CNN classification set includes a second CNN classification that satisfies the following condition: the second CNN classification belongs to the digit set, a second CNN classification confidence corresponding to the second CNN classification is larger than a second CNN threshold, and a character block corresponding to the second CNN classification has a digit character block directly adjacent to the character block. The digit character block is composed of characters “0”, “1”, “2”, “3”, “4”, “5”, “6”, “7”, “8” and “9”.

If it is determined in step 511 that the CNN classification set includes the second CNN classification, step 531 is performed to select the character block corresponding to the second CNN classification as the seed character block.

If it is determined in step 511 that the CNN classification set does not include the second CNN classification, step 513 is performed to determine whether the FCN classification set includes a third FCN classification that satisfies the following condition: the third FCN classification belongs to the digit set, a third FCN classification confidence corresponding to the third FCN classification is larger than a third FCN threshold, and a character block corresponding to the third FCN classification has a digit character block directly adjacent to the character block.

If it is determined in step 513 that the FCN classification set includes the third FCN classification, step 533 is performed to select the character block corresponding to the third FCN classification as the seed character block.

If it is determined in step 513 that the FCN classification set does not include the third FCN classification, step 515 is performed to output prompt information, in order that a user performs a corresponding operation on the image in such condition. The prompt information may be information indicating that the seed character block is not found, such as “seed character block not found” or “seed character block not discovered”.

In the method 101b of selecting the seed character block, the seed character block is selected by using the CNN classifier and the FCN classifier, to accurately and rapidly determine the seed character block. Moreover, the characters in the middle address are classified into three categories (the first character subset, the character “−”, and the digit set). The seed character block is selected according to the categories and priorities, which is advantageous for further improving the accuracy of the recognition. In the method 101b, after characters in the image of the entire Japanese recipient address is recognized, it is determined whether the character blocks corresponding to characters of various categories are seed character blocks according to priorities.

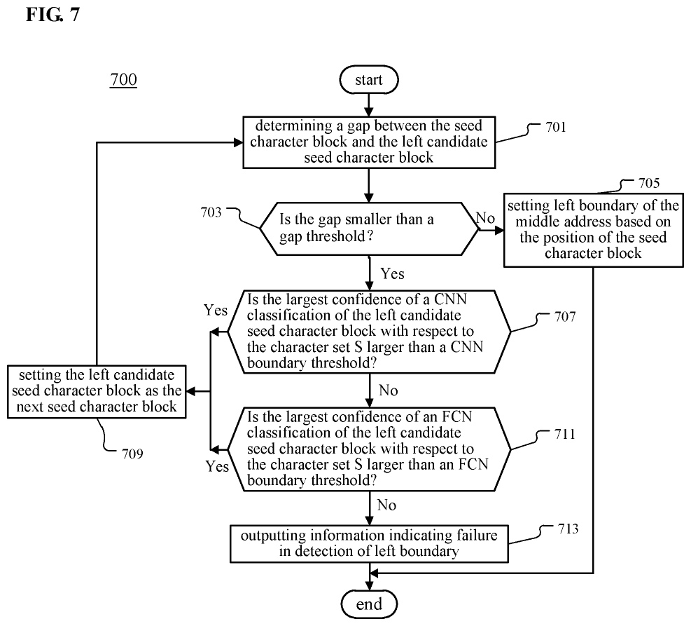

FIG. 6 is an exemplary flow chart of a method 101c for selecting a seed character block according to another embodiment of the present disclosure. The selecting unit 11 in the device 10 may be configured to implement the method 101c.

In step 601, the CNN classification of each character block and the CNN classification confidence of the CNN classification are determined by classifying character blocks with respect to the character set S by using the CNN classifier. The CNN classification of each character block may be the classification with the largest confidence among the CNN candidate classifications of the character block with respect to the character set S.

In step 603, the FCN classification of each character block and the FCN classification confidence of the FCN classification are determined by classifying character blocks in the image with respect to the character set S by using the FCN classifier. The FCN classification of each character block may be the classification with the largest confidence among the FCN candidate classifications of the character block with respect to the character set S.

In step 605, it is determined whether a confidence of a first most credible CNN classification having the largest confidence in a first CNN classification set is larger than the first CNN threshold. The first CNN classification set is composed of classifications satisfying the following condition among the respective CNN classifications: the classification belongs to the first character subset, and a character block corresponding to the classification has a digit character block directly adjacent to the character block. The first character subset is composed of characters “ [symbol] ”, “ [symbol] ”, “ [symbol] ”, “ [symbol] ” and “ [symbol] ”. The digit character block satisfies the following condition: a confidence that the character block is recognized as one of characters “0”, “1”, “2”, “3”, “4”, “5”, “6”, “7”, “8” and “9” is larger than a predetermined threshold. The digit character block may be determined by directly using the generated CNN classification result, or by using classification results of other classifiers such as FCN classifier.

If it is determined in step 605 that, the confidence of the first most credible CNN classification having the largest confidence in the first CNN classification set is larger than the first CNN threshold, step 625 is performed to select a character block corresponding to the first most credible CNN classification as the seed character block.

If it is determined in step 605 that, the confidence of the first most credible CNN classification having the largest confidence in the first CNN classification set is not larger than the first CNN threshold, step 607 is performed to determine whether a confidence of a first most credible FCN classification having the largest confidence in a first FCN classification set is larger than a first FCN threshold. The first FCN classification set is composed of classifications satisfying the following conditions among respective FCN classifications: the classification belongs to the first character subset, and the character block corresponding to the classification has a digit character block directly adjacent to the character block. The digit character block may be determined by directly using the generated FCN classification result, or by using other classifiers.

If it is determined in step 607 that, the confidence of the first most credible FCN classification having the largest confidence in the first FCN classification set is larger than the first FCN threshold, step 627 is performed to determine a character block corresponding to the first most credible FCN classification as the seed character block.

If it is determined in step 607 that, the confidence of the first most credible FCN classification having the largest confidence in the first FCN classification set is not larger than the first FCN threshold, step 609 is performed to determine whether a confidence of a second most credible FCN classification having the largest confidence in a second FCN classification set is larger than a second FCN threshold. The second FCN classification set is composed of classifications satisfying the following conditions among respective FCN classifications: the classification is the character “−”, and a character block corresponding to the classification has a digit character block directly adjacent to the character block.

If it is determined in step 609 that, the confidence of the second most credible FCN classification is larger than the second FCN threshold, step 629 is performed to select a character block corresponding to the second FCN classification as the seed character block.

If it is determined in step 609 that, the confidence of the second most credible FCN classification is not larger than the second FCN threshold, step 611 is performed to determine whether a confidence of a second most credible CNN classification having the largest confidence in a second CNN classification set is larger than a second CNN threshold. The second CNN classification set is composed of classifications satisfying the following conditions among respective CNN classifications: the classification belongs to the digit set, and a character block corresponding to the classification has a digit character block directly adjacent to the character block. The digit set is composed of characters “0”, “1”, “2”, “3”, “4”, “5”, “6”, “7”, “8” and “9”. The digit character block may be determined by directly using the generated CNN classification result, or by using classification results of other classifiers such as FCN classifier.

If it is determined in step 611 that, the confidence of the second most credible CNN classification having the largest confidence in the second CNN classification set is larger than the second CNN threshold, step 631 is performed to select the character block corresponding to the second most credible CNN classification as a seed character block.

If it is determined in step 611 that, the confidence of the second most credible CNN classification having the largest confidence in the second CNN classification set is not larger than the second CNN threshold, step 613 is performed to determine whether a confidence of a third most credible FCN classification having the largest confidence in a third FCN classification set is larger than a third FCN threshold. The third FCN classification set is composed of classifications satisfying the following conditions among respective FCN classifications: the classification belongs to the digit set, and a character block corresponding to the classification has a digit character block directly adjacent to the character block. The digit character block may be determined by directly using the generated CNN classification result, or by using classification results of other classifiers such as FCN classifier.

If it is determined in step 613 that, the confidence of the third most credible FCN classification having the largest confidence in the third FCN classification set is larger than the third FCN threshold, step 633 is performed to select a character block corresponding to the third most credible FCN classification as the seed character block.

If it is determined in step 613 that, the confidence of the third most credible FCN classification having the largest confidence in the third FCN classification set is not larger than the third FCN threshold, step 615 is performed to output prompt information, in order that a user performs a corresponding operation on the image in such condition. The prompt information may be information indicating that the seed character block is not found, such as “seed character block not found” or “seed character block not discovered”.

In the method 101c of selecting the seed character block, the seed character block is selected by using the CNN classifier and the FCN classifier, to accurately and rapidly determine the seed character block. Moreover, the characters in the middle address are classified into three categories (the first character subset, the character “−”, and the digit set). The seed character block is selected according to the categories and priorities, which is advantageous for further improving the accuracy of the recognition. In the method 101c, after characters in the image of the entire Japanese recipient address is recognized, the seed character block is determined for characters of various categories according to priorities, and the character block that satisfies the condition and has the highest confidence in each set is determined as the seed character block, thereby further improving the accuracy of recognizing the seed character block.

The method for determining a seed character block according to the present disclosure is not limited to the methods 101a-101c, but also includes variations of the methods in which the CNN classifier and the FCN classifier are used in combination.

After the seed character block is determined, an area of a middle address of the Japanese recipient address can be determined in the image, starting from the seed character block.

An area between the left boundary character block and the right boundary character block (including an area of the left boundary character block and an area of the right boundary character block) is defined as the area of the middle address of the Japanese recipient address.

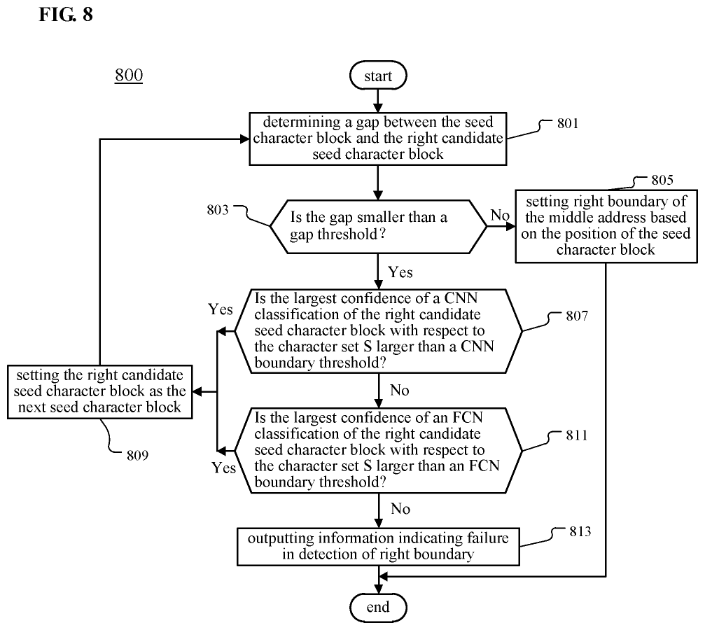

A method for determining a left boundary of the area of the middle address of the Japanese recipient address according to the present disclosure is described below with reference to FIG. 7.

FIG. 7 is an exemplary flow chart of a method 700 for determining the left boundary of the area of the middle address of the Japanese recipient address according to an embodiment of the present disclosure.

In step 701, a gap between the seed character block and a left candidate seed character block is determined. The left candidate seed character block refers to a character block directly adjacent to the seed character block on the left side of the seed character block.

In step 703, it is determined whether the gap is smaller than a gap threshold. The gap threshold may be set to 1.5 to 2.5 times a median value of gaps between adjacent character blocks of the Japanese recipient address in the image, or 1.5 to 2.5 times an average value of the gaps.

If it is determined that the gap is not smaller than the gap threshold, step 705 is performed to set a left boundary of the middle address based on the position of the seed character block. For example, the seed character block is set as the left boundary character block.

If it is determined that the gap is smaller than the gap threshold, step 707 is performed to determine whether a largest confidence of a CNN classification of the left candidate seed character block with respect to the character set S is larger than a CNN boundary threshold. The CNN classification with respect to the character set S is a classification belonging to the character set S provided by CNN classifier when the character block is classified by using the CNN classifier.

If it is determined in step 707 that the largest confidence of the CNN classification of the left candidate seed character block with respect to the character set S is larger than the CNN boundary threshold, step 709 is performed to set the left candidate seed character block as a next seed character block. Then, the procedure returns to step 701, where a gap between the seed character block and the left candidate seed character block is determined based on the newly determined seed character block.

If the determination result in step 707 is negative, step 711 is performed to determine whether a largest confidence of an FCN classification of the left candidate seed character block with respect to the character set S is larger than an FCN boundary threshold. The FCN classification with respect to the character set S is a classification belonging to the character set S provided by the FCN classifier when the character block is classified by the FCN classifier.

A method for determining a right boundary of the area of the middle address of the Japanese recipient address according to the present disclosure is described below with reference to FIG. 8.

FIG. 8 is an exemplary flow chart of a method 800 for determining the right boundary of the area of the middle address of the Japanese recipient address according to an embodiment of the present disclosure.

In step 801, a gap between the seed character block and a right candidate seed character block is determined. The right candidate seed character block refers to a character block directly adjacent to the seed character block on the right side of the seed character block.

In step 803, it is determined whether the gap is smaller than a gap threshold. The gap threshold may be set to 1.5 to 2.5 times a median value of gaps between adjacent character blocks of the Japanese recipient address in the image, or 1.5 to 2.5 times an average value of the gaps.

If it is determined that the gap is not smaller than the gap threshold, step 805 is performed to set a right boundary of the middle address based on the seed character block. For example, the seed character block is set as the right boundary character block.

If it is determined that the gap is smaller than the gap threshold, step 807 is performed to determine whether a largest confidence of a CNN classification of the right candidate seed character block with respect to the character set S is larger than a CNN boundary threshold. The CNN classification with respect to the character set S is a classification belonging to the character set S provided by CNN classifier when the character block is classified by using the CNN classifier.

If it is determined in step 807 that the largest confidence of the CNN classification of the right candidate seed character block with respect to the character set S is larger than the CNN boundary threshold, step 809 is performed to set the right candidate seed character block as a next seed character block. Then, the procedure returns to step 801, where a gap between the seed character block and the right candidate seed character block is determined based on the newly determined seed character block.

If the determination result in step 807 is negative, step 811 is performed to determine whether a largest confidence of an FCN classification of the right candidate seed character block with respect to the character set S is larger than an FCN boundary threshold. The FCN classification with respect to the character set S is a classification belonging to the character set S provided by the FCN classifier when the character block is classified by the FCN classifier.

According to the method 700 and the method 800, the area of the middle address is determined by using boundary character blocks. However, since the boundary character block has center position coordinates, left boundary coordinates, and right boundary coordinates, these coordinates can also be used to define the area of the middle address. Alternatively, the representation of the area of the middle address may be replaced by another representation.

The inventors found that the seed character block is determined by using the CNN classifier and the FCN classifier according to priorities according to the present disclosure, which improves the accuracy of determining the seed character block. On this basis, the CNN classifier and the FCN classifier are used in combination to classify character blocks on the left side and on the right side of the seed character block to determine the area of the middle address of the Japanese recipient address, which is advantageous for improving the accuracy of determining the area of the middle address.

A method for processing an image according to the present disclosure is described below.

FIG. 9 is an exemplary flow chart of a method 900 for processing an image according to an embodiment of the present disclosure. The method 900 includes the following step 901 and 903. In step 901, character blocks in the image are recognized by using a convolutional network (CNN) classifier or a fully convolutional network (FCN) classifier, to select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”. In step 903, an area of a middle address of a Japanese recipient address is determined in the image, starting from the seed character block. The method 900 corresponds to the configuration of the device 10. Therefore, in some embodiments, one can refer to the corresponding detailed description of the device disclosed in the present disclosure for a more detailed design of method 900.

The inventors found that it is a preferred solution to use the CNN classifier and the FCN classifier to determine characters in a middle address based on categories. This is advantageous for improving the accuracy of determining the area of the middle address, and further facilitates accurate and efficient identification of the characters of the middle address and the entire Japanese recipient address in subsequent procedures.

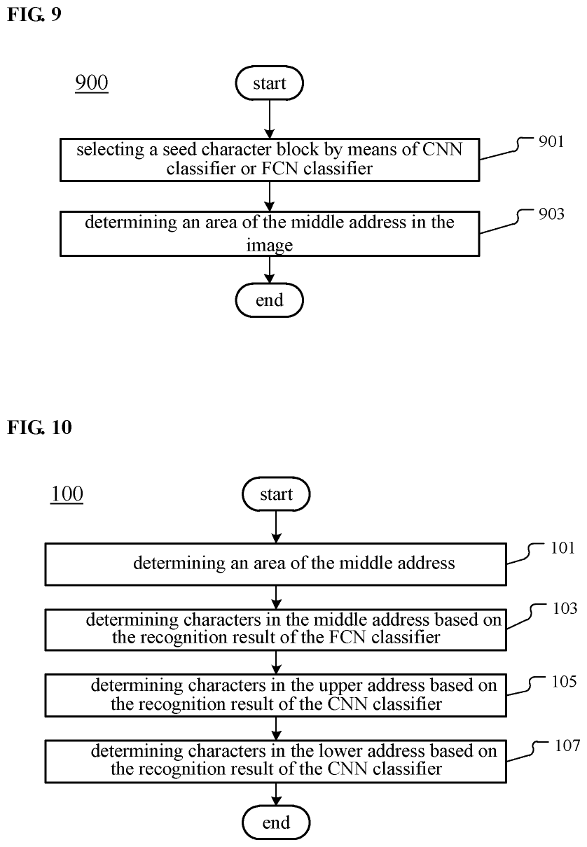

The present disclosure relates to a method for recognizing a Japanese recipient address in an image. FIG. 10 is an exemplary flow chart of a method 100 for recognizing a Japanese recipient address in an image according to an embodiment of the present disclosure.

In step 101, an area of a middle address is determined by using the method 900 according to the present disclosure.

In step 103, characters in the middle address in the image are determined based on the recognition result of the FCN classifier.

In step 105, characters in the upper address in the image are determined based on the recognition result of the CNN classifier.

In step 107, characters in the lower address in the image are determined based on the recognition result of the CNN classifier.

Alternatively, characters in the upper address and the lower address in the image may be recognized by using other classifiers.

The present disclosure further relates to a method for classifying a postal matter having a Japanese recipient address. The method includes: classifying a postal matter based on the Japanese recipient address recognized according to the present disclosure.

The present disclosure further relates to a device for classifying a postal matter having a Japanese recipient address. The device is configured to classify a postal matter based on the Japanese recipient address recognized according to the present disclosure.

In an embodiment, a storage medium is provided according to the present disclosure. Program codes that are readable by an information processing device are stored on the storage medium. When being executed on the information processing device, the program codes cause the information processing device to perform the above method according to the present disclosure. The storage medium includes but is not limited to a floppy disk, an optical disk, a magneto-optical disk, a memory card, a memory stick, and the like.

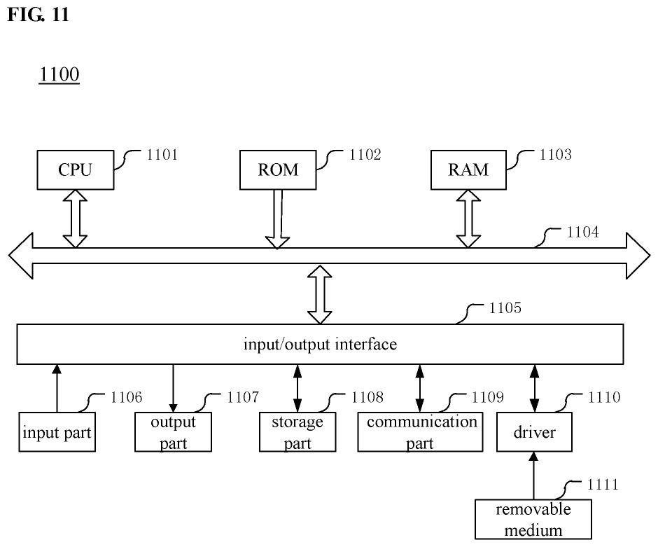

FIG. 11 is an exemplary block diagram of an information processing device 1100 according to an embodiment of the present disclosure.

As shown in FIG. 11, a central processing unit (CPU) 1101 performs various processing according to a program stored in a read-only memory (ROM) 1102 or a program loaded to a random access memory (RAM) 1103 from a storage section 1108. The data needed for the various processing of the CPU 1101 may be stored in the RAM 1103 as needed.

The CPU 1101, the ROM 1102, and the RAM 1103 are connected to each other via a bus 1104. An input/output interface 1105 is also connected to the bus 1104.

The input/output interface 1105 is connected with an input part 1106 (including a soft keyboard and the like), an output part 1107 (including a display such as Liquid Crystal Display (LCD), loudspeaker and the like), a storage part 1108 (including hard disk), and a communication part 1109 (including network interface card such as LAN card, modem and the like). The communication part 1109 performs communication processing via a network such as the Internet and local area network.

A driver 1110 may be connected with the input/output interface 1105 as needed. A removable medium 1111 such as semiconductor memory is installed in the driver 1110 as needed, such that a computer program read from the removable medium 1111 may be installed in the storage part 1108 as needed.

The CPU 1101 may execute the program codes for implementing the method according to the present disclosure.

With the method and the device according to the present disclosure, various types of characters in a middle address are recognized according to priorities by using multiple methods in combination, to achieve at least the following beneficial effects: improving the efficiency and accuracy of recognition.

The present disclosure is described by the foregoing description of the embodiments of the present disclosure. However, it should be understood that, the person skilled in the art can design various modifications (including combination or substitution of features among embodiments), improvements and equivalents to the present disclosure in the spirit and scope defined by the appended claims. Such modifications, improvements, or equivalents are also considered to be included within the scope of the present disclosure.

It should be emphasized that terms of “include”, “comprise” are used in the present disclosure to indicate the presence of a feature, an element, a step, or a component, but do not exclude the presence or addition of one or more other features, elements, steps or components.

Further, the methods of the various embodiments of the present invention are not limited to being performed in the chronological order described in the specification or shown in the drawings, and may be performed in other chronological order, in parallel or independently. Therefore, the order of execution of the methods described in the present specification does not limit the technical scope of the present disclosure.

### Appendix

1. A device for processing an image, including:
a selecting unit configured to, by recognizing character blocks in the image using a convolutional network classifier or a fully convolutional network classifier, select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and
a determining unit configured to determine an area of a middle address of a Japanese recipient address in the image, starting from the seed character block.

2. The device according to appendix 1, where the fully convolutional network classifier is configured for determining a confidence that a character block to be classified in the image is a character in the character set, regardless of whether the character block to be classified is a character other than characters in the character set.

3. The device according to appendix 1, where recognizing character blocks in the image using the convolutional network classifier includes performing over-segmentation on an area in the image where characters locate.

4. The device according to appendix 3, where the selecting unit is configured to:
if a first CNN seed character block is obtained when classifying the character blocks in the image by using the convolutional network classifier, select the first CNN seed character block as the seed character block; where the first CNN seed character block satisfies the following condition: a largest CNN classification confidence of a CNN classification of the first CNN seed character block with respect to a first character subset is larger than a first CNN threshold, and the first CNN seed character block has a digit character block directly adjacent to the first CNN seed character block;
if the first CNN seed character block is not obtained when classifying the character blocks in the image by using the convolutional network classifier, in a case that a first FCN seed character block is obtained when classifying the character blocks in the image by using the fully convolutional network classifier, select the first FCN seed character block as the seed character block; where the first FCN seed character block satisfies the following condition: a largest FCN classification confidence of an FCN classification of the first FCN seed character block with respect to the first character subset is larger than a first FCN threshold, and the first FCN seed character block has the digit character block directly adjacent to the first FCN seed character block;
where the first character subset is composed of characters “ [symbol] ”, “ [symbol] ”, “ [symbol] ”, “ [symbol] ” and “ [symbol] ”; and
the digit character block is a character block satisfying the following condition: a confidence that the character block is recognized as one of characters “0”, “1”, “2”, “3”, “4”, “5”, “6”, “7”, “8” and “9” is larger than a predetermined threshold.

5. The device according to appendix 4, where the selecting unit is configured to:
if the first FCN seed character block is not obtained when classifying the character blocks in the image by using the fully convolutional network classifier, in a case that a second FCN seed character block is obtained when classifying the character blocks in the image by using the fully convolutional network classifier, select the second FCN seed character block as the seed character block; where the second FCN seed character block satisfies the following condition: an FCN classification confidence of an FCN classification of the second FCN seed character block with respect to the character “−” is larger than a second FCN threshold, and the second FCN seed character block has the digit character block directly adjacent to the second FCN seed character block.

6. The device according to appendix 5, where the selecting unit is configured to:
if the second FCN seed character block is not obtained when classifying the character blocks in the image by using the fully convolutional network classifier, then
if a second CNN seed character block is obtained when classifying the character blocks in the image by using the convolutional network classifier, select the second CNN seed character block as the seed character block; where the second CNN seed character block satisfies the following condition: a largest CNN classification confidence of a CNN classification of the second CNN seed character block with respect to a digit set is larger than a second CNN threshold, and the second CNN seed character block has the digit character block directly adjacent to the second CNN seed character block;
if the second CNN seed character block is not obtained when classifying the character blocks in the image by using the convolutional network classifier, in a case that a third FCN seed character block is obtained when classifying the character blocks in the image by using the fully convolutional network classifier, select the third FCN seed character block as the seed character block; where the third FCN seed character block satisfies the following condition: a largest FCN classification confidence of an FCN classification of the third FCN seed character block with respect to the digit set is larger than a third FCN threshold, and the third FCN seed character block has the digit character block directly adjacent to the third FCN seed character block;
where the digit set is composed of characters “0”, “1”, “2”, “3”, “4”, “5”, “6”, “7”, “8” and “9”.

7. The device according to appendix 1, where the selecting unit is configured to:
perform classifications on the respective character blocks with respect to the character set by using the convolutional network classifier, to determine CNN classifications and CNN classification confidences of the respective character blocks;
perform classifications on the respective character blocks with respect to the character set by using the fully convolutional network classifier, to determine FCN classifications and FCN classification confidences of the respective character blocks.

8. The device according to appendix 7, where the selecting unit is configured to:
select a character block corresponding to a first CNN classification as a seed character block, if a CNN classification set composed of the respective CNN classifications includes the first CNN classification satisfying the following conditions: the first CNN classification belongs to a first character subset, a first CNN classification confidence corresponding to the first CNN classification is larger than a first CNN threshold, and the character block corresponding to the first CNN classification has a digit character block directly adjacent to the character block;
where the first character subset is composed of characters “ [symbol] ”, “ [symbol] ”, “ [symbol] ”, “ [symbol] ” and “ [symbol] ”; and
the digit character block is a character block satisfying the following condition: a confidence that the character block is recognized as one of characters “0”, “1”, “2”, “3”, “4”, “5”, “6”, “7”, “8” and “9” is larger than a predetermined threshold.

9. The method according to appendix 8, where the selecting unit is configured to:
if the CNN classification set does not comprise the first CNN classification,
determine a character block corresponding to a first FCN classification as the seed character block if an FCN classification set composed of FCN classifications includes the first FCN classification that meets the following condition: the first FCN classification belongs to the first character subset, a first FCN classification confidence corresponding to the first FCN classification is larger than a first FCN threshold, and the character block corresponding to the first FCN classification has a digit character block directly adjacent to the character block.

10. The device according to appendix 9, where the selecting unit is configured to:
if the FCN classification set does not comprise the first FCN classification,
determine a character block corresponding to a second FCN classification as the seed character block if the FCN classification set includes the second FCN classification that meets the following condition: the second FCN classification is the character “−”, a second FCN classification confidence corresponding to the second FCN classification is larger than a second FCN threshold, and a character block corresponding to the second FCN classification has a digit character block directly adjacent to the character block.

11. The device according to appendix 10, where the selecting unit is configured to:
if the FCN classification set does not comprise the second FCN classification,
determine a character block corresponding to a second CNN classification as the seed character block if the CNN classification set includes a second CNN classification that meets the following condition: the second CNN classification belongs to the digit set, a second CNN classification confidence corresponding to the second CNN classification is larger than a second CNN threshold, and a character block corresponding to the second CNN classification has a digit character block directly adjacent to the character block,
where the digit character block is composed of characters “0”, “1”, “2”, “3”, “4”, “5”, “6”, “7”, “8” and “9”.

12. The device according to appendix 11, where the selecting unit is configured to:
if the CNN classification set does not include the second CNN classification,
select a character block corresponding to a third FCN classification as the seed character block if the FCN classification set includes the third FCN classification that meets the following condition: the third FCN classification belongs to the digit set, a third FCN classification confidence corresponding to the third FCN classification is larger than a third FCN threshold, and a character block corresponding to the third FCN classification has a digit character block directly adjacent to the character block.

13. The device according to appendix 7, where the selecting unit is configured to:
if a confidence of a first most credible CNN classification having the largest confidence in a first CNN classification set is larger than the first CNN threshold, select a character block corresponding to the first most credible CNN classification as the seed character block;
where the first CNN classification set is composed of classifications satisfying the following conditions among the respective CNN classifications: the classification belongs to the first character subset, and a character block corresponding to the classification has a digit character block directly adjacent to the character block;
the first character subset is composed of characters “ [symbol] ”, “ [symbol] ”, “ [symbol] ”, “ [symbol] ” and “ [symbol] ”, and
the digit character block satisfies the following condition: a confidence that the character block is recognized as one of characters “0”, “1”, “2”, “3”, “4”, “5”, “6”, “7”, “8” and “9” is larger than a predetermined threshold.

14. The device according to appendix 13, where the selecting unit is configured to:
if the confidence of the first most credible CNN classification having the largest confidence in the first CNN classification set is not larger than the first CNN threshold,
determine a character block corresponding to a first most credible FCN classification as the seed character block if a confidence of the first most credible FCN classification having the largest confidence in a first FCN classification set is larger than a first FCN threshold, where the first FCN classification set is composed of classifications satisfying the following conditions among the respective FCN classifications: the classification belongs to the first character subset, and a character block corresponding to the classification has a digit character block directly adjacent to the character block.

15. The device according to appendix 14, where the selecting unit is configured to:
if the confidence of the first most credible FCN classification having the largest confidence in the first FCN classification set is not larger than a first FCN threshold,
select a character block corresponding to a second most credible FCN classification as the seed character block, if a confidence of the second most credible FCN classification having the largest confidence in a second FCN classification set is larger than a second FCN threshold;
where the second FCN classification set is composed of classifications satisfying the following condition among respective FCN classifications: the classification is the character “−”, and a character block corresponding to the classification has a digit character block directly adjacent to the character block.

16. The device according to appendix 15, where the selecting unit is configured to:
select a character block corresponding to a second most credible CNN classification as a seed character block if a confidence of the second most credible CNN classification having the largest confidence in a second CNN classification set is larger than a second CNN threshold,
where the second CNN classification set is composed of classifications satisfying the following conditions among respective CNN classifications: the classification belongs to the digit set, and a character block corresponding to the classification has a digit character block directly adjacent to the character block; and
where digit set is composed of characters “0”, “1”, “2”, “3”, “4”, “5”, “6”, “7”, “8” and “9”.

17. The device according to appendix 16, where the selecting unit is configured to:
if the confidence of the second most credible CNN classification is not larger than the second CNN threshold,
select a character block corresponding to a third most credible FCN classification as the seed character block if a confidence of the third most credible FCN classification having the largest confidence in a third FCN classification set is larger than a third FCN threshold;
where the third FCN classification set is composed of classifications satisfying the following conditions among respective FCN classifications: the classification belongs to the digit set, and a character block corresponding to the classification has a digit character block directly adjacent to the character block.

18. The device according to appendix 1, where the determining unit is configured to:
detect a gap between the seed character block and a left candidate seed character block on the left side of the seed character block; and
set a left boundary of the middle address based on the position of the seed character block if the gap is larger than a gap threshold; otherwise
set the left candidate seed character block as a next seed character block if the convolutional network classifier determines a character corresponding to the left candidate seed character block belongs to the character set; otherwise,
set the left candidate seed character block as the next seed character block if the convolutional network classifier determines the character corresponding to the left candidate seed character block belongs to the character set; otherwise, set the left boundary of the middle address based on the seed character block.

19. The device according to appendix 1, where the determining unit is configured to:
detect a gap between the seed character block and a right candidate seed character block on the right side of the seed character block; and
set a right boundary of the middle address based on the position of the seed character block if the gap is larger than a gap threshold; otherwise
set the right candidate seed character block as a next seed character block if the convolutional network classifier determines a character corresponding to the right candidate seed character block belongs to the character set; otherwise
set the right candidate seed character block as the next seed character block if the convolutional network classifier determines the character corresponding to the right candidate seed character block belongs to the character set; otherwise, set the right boundary of the middle address based on the seed character block.

20. A method of processing an image, including:
recognizing character blocks in the image by using a convolutional network classifier or a fully convolutional network classifier, to select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and
determining an area of a middle address of a Japanese recipient address in the image, starting from the seed character block.

1. A device for processing an image, comprising:
a selecting unit configured to, by recognizing character blocks in the image using a convolutional network classifier or a fully convolutional network classifier, select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and
a determining unit configured to determine an area of a middle address of a Japanese recipient address in the image, starting from the seed character block.

2. The device according to claim 1, wherein the fully convolutional network classifier is configured for determining a confidence that a character block to be classified in the image is a character in the character set, regardless of whether the character block to be classified is a character other than characters in the character set.

3. The device according to claim 1, wherein recognizing character blocks in the image using the convolutional network classifier comprises performing over-segmentation on an area in the image where characters locate.

4. The device according to claim 3, wherein the selecting unit is configured to:
if a first CNN seed character block is obtained when classifying the character blocks in the image by using the convolutional network classifier, select the first CNN seed character block as the seed character block; wherein the first CNN seed character block satisfies the following condition: a largest CNN classification confidence of a CNN classification of the first CNN seed character block with respect to a first character subset is larger than a first CNN threshold, and the first CNN seed character block has a digit character block directly adjacent to the first CNN seed character block;
if the first CNN seed character block is not obtained when classifying the character blocks in the image by using the convolutional network classifier, in a case that a first FCN seed character block is obtained when classifying the character blocks in the image by using the fully convolutional network classifier, select the first FCN seed character block as the seed character block; wherein the first FCN seed character block satisfies the following condition: a largest FCN classification confidence of an FCN classification of the first FCN seed character block with respect to the first character subset is larger than a first FCN threshold, and the first FCN seed character block has the digit character block directly adjacent to the first FCN seed character block;
wherein the first character subset is composed of characters “ [symbol] ”, “ [symbol] ”, “ [symbol] ”, “ [symbol] ” and “ [symbol] ”; and
the digit character block is a character block satisfying the following condition: a confidence that the character block is recognized as one of characters “0”, “1”, “2”, “3”, “4”, “5”, “6”, “7”, “8” and “9” is larger than a predetermined threshold.

5. The device according to claim 4, wherein the selecting unit is configured to:
if the first FCN seed character block is not obtained when classifying the character blocks in the image by using the fully convolutional network classifier, in a case that a second FCN seed character block is obtained when classifying the character blocks in the image by using the fully convolutional network classifier, select the second FCN seed character block as the seed character block; wherein the second FCN seed character block satisfies the following condition: an FCN classification confidence of an FCN classification of the second FCN seed character block with respect to the character “−” is larger than a second FCN threshold, and the second FCN seed character block has the digit character block directly adjacent to the second FCN seed character block.

6. The device according to claim 5, wherein the selecting unit is configured to:
if the second FCN seed character block is not obtained when classifying the character blocks in the image by using the fully convolutional network classifier, then
if a second CNN seed character block is obtained when classifying the character blocks in the image by using the convolutional network classifier, select the second CNN seed character block as the seed character block; wherein the second CNN seed character block satisfies the following condition: a largest CNN classification confidence of a CNN classification of the second CNN seed character block with respect to a digit set is larger than a second CNN threshold, and the second CNN seed character block has the digit character block directly adjacent to the second CNN seed character block;
if the second CNN seed character block is not obtained when classifying the character blocks in the image by using the convolutional network classifier, in a case that a third FCN seed character block is obtained when classifying the character blocks in the image by using the fully convolutional network classifier, select the third FCN seed character block as the seed character block; wherein the third FCN seed character block satisfies the following condition: a largest FCN classification confidence of an FCN classification of the third FCN seed character block with respect to the digit set is larger than a third FCN threshold, and the third FCN seed character block has the digit character block directly adjacent to the third FCN seed character block;
wherein the digit set is composed of characters “0”, “1”, “2”, “3”, “4”, “5”, “6”, “7”, “8” and “9”.

7. The device according to claim 1, wherein the selecting unit is configured to:
perform classifications on the respective character blocks with respect to the character set by using the convolutional network classifier, to determine CNN classifications and CNN classification confidences of the respective character blocks;
perform classifications on the respective character blocks with respect to the character set by using the fully convolutional network classifier, to determine FCN classifications and FCN classification confidences of the respective character blocks.

8. The device according to claim 7, wherein the selecting unit is configured to:
select a character block corresponding to a first CNN classification as a seed character block, if a CNN classification set composed of the respective CNN classifications includes the first CNN classification satisfying the following conditions: the first CNN classification belongs to a first character subset, a first CNN classification confidence corresponding to the first CNN classification is larger than a first CNN threshold, and the character block corresponding to the first CNN classification has a digit character block directly adjacent to the character block;
wherein the first character subset is composed of characters “ [symbol] ”, “ [symbol] ”, “ [symbol] ”, “ [symbol] ” and “ [symbol] ”; and
the digit character block is a character block satisfying the following condition: a confidence that the character block is recognized as one of characters “0”, “1”, “2”, “3”, “4”, “5”, “6”, “7”, “8” and “9” is larger than a predetermined threshold.

9. The device according to claim 7, wherein the selecting unit is configured to:
if a confidence of a first most credible CNN classification having a largest confidence in a first CNN classification set is larger than the first CNN threshold, select a character block corresponding to the first most credible CNN classification as the seed character block;
wherein the first CNN classification set is composed of classifications satisfying the following conditions among the respective CNN classifications: the classifications belong to a first character subset, and character blocks corresponding to the classifications have digit character blocks directly adjacent to the character block;
wherein the first character subset is composed of characters “ [symbol] ”, “ [symbol] ”, “ [symbol] ”, “ [symbol] ” and “ [symbol] ”; and
the digit character block is a character block satisfying the following condition: a confidence that the character block is recognized as one of characters “0”, “1”, “2”, “3”, “4”, “5”, “6”, “7”, “8” and “9” is larger than a predetermined threshold.

10. A method of processing an image, comprising steps of:
recognizing character blocks in the image by using a convolutional network (CNN) classifier or a fully convolutional network (FCN) classifier, to select in the image a seed character block satisfying a condition that a result of recognizing the seed character block is one of elements of a character set composed of characters “ [symbol] ”, “ [symbol] ”, “ [symbol] ”, “ [symbol] ”, “ [symbol] ”, “−”, “0”, “1”, “2”, “3”, “4”, “5”, “6”, “7”, “8” and “9”; and
determining an area of a middle address of a Japanese recipient address in the image, starting from the seed character block.
